(19) United States
(12) Patent Application Publication
(10) Pub. No.: US 2018/0132474 A1
(43) Pub. Date: May 17, 2018

(54) MOUSETRAP APPARATUS

(71) Applicant: William Thomas Webster, Nevada, IA (US)

(72) Inventor: William Thomas Webster, Nevada, IA (US)

(21) Appl. No.: 15/815,557

(22) Filed: Nov. 16, 2017

Related U.S. Application Data
(60) Provisional application No. 62/423,436, filed on Nov. 17, 2016.

(51) Int. Cl. A01M 23/30; A01M 31/00

(52) U.S. Cl. CPC A01M 23/30; A01M 31/006

(57) ABSTRACT

An improved mousetrap apparatus comprising: a platform including a top surface; a spring; a hammer; a hold down bar; an improved catch member having a catch platform; an attachment member; and at least one elongated strap member including a proximal end and a distal end. The improved mousetrap apparatus is structured and arranged to function as a bait holder such that a rodent may not easily remove the bait from a mouse trap.

### CROSS-REFERENCE TO RELATED APPLICATION

The present application is related to and claims priority from prior provisional application Ser. No. 62/423,436, filed Nov. 17, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of rodent trap devices and more specifically relates to an improved mousetrap apparatus structured and arranged to function as a bait holder such that a rodent may not easily remove the bait from a mouse trap.

### 2. DESCRIPTION OF THE RELATED ART

Rodent populations have been known to live side by side with humans and usually prosper from human development. A mousetrap is an animal trap designed to trap mice and other small animals. Mousetraps help reduce rodent populations that have infested an indoor location. The spring-loaded mousetrap is a simple device with a heavily spring-loaded bar and a trip to release it. Cheese may be placed on the trip as bait, but other food such as oats, chocolate, bread, meat, butter and peanut butter are more commonly used. The spring-loaded bar swings down rapidly and with great force when anything, usually a mouse, touches the trip.

The design is such that the mouse's neck or spinal cord will be broken, or its ribs or skull crushed, by the force of the bar. The trap can be held over a bin and the dead mouse released into it by pulling the bar. In the case of rats, which are much larger than mice, a much larger version of the same type of trap is used to kill them. Some spring mousetraps have a plastic extended trip. The larger trip has two notable differences over the smaller traditional type: increased leverage, which requires less force from the rodent to trip it; and the larger surface area of the trip increases the probability that even the most cunning of rodents will set off the trap. The exact latching mechanism holding the trip varies a lot and some need to be set right at the edge in order to be sensitive enough to catch cautious mice.

Unfortunately, the mousetrap is not always successful at catching a rodent with its bait, due to rodents removing the bait from the trap without getting caught. As such, an improved mouse trap that catches more rodents is needed.

Various attempts have been made to solve problems found in rodent trap devices art. Among these are found in: U.S. Pat. No. 2,524,324 to Martin Trevellic O; U.S. Pat. No. 5,259,152 to Janice D. Taylor; and U.S. Pat. No. 4,360,986 to Phillip Dushey. This prior art is representative of bait holder rodent trap devices.

Ideally, an improved mousetrap apparatus should be user-friendly and safe in-use and, yet should operate reliably and be manufactured at a modest expense. Thus, a need exists for an improved mousetrap apparatus structured and arranged to function as a bait holder such that a rodent may not easily remove the bait from a mouse trap and to avoid the above-mentioned problems.

### BRIEF SUMMARY OF THE INVENTION

In view of the foregoing disadvantages inherent in the known rodent trap devices art, the present invention provides an improved mousetrap apparatus. The general purpose of the present invention, which will be described subsequently in greater detail is to provide an improved mousetrap apparatus structured and arranged to function as a bait holder such that a rodent may not easily remove the bait from a mouse trap.

An improved mousetrap apparatus comprising: a platform including a top surface; a spring; a hammer; a hold down bar; an improved catch member having a catch platform; an attachment member; and at least one elongated strap member including a proximal end and a distal end. The spring is attached to the top surface of the platform. Wherein the hammer is connected to the spring and is adapted to pivot with respect to the platform. Wherein the hold down bar is connected to the top surface of the platform at a proximal end thereof, and is adapted to removably hold down the hammer in a tensioned state via the spring.

The catch platform comprises a top surface, a bottom surface, and a hold down bar attachment member. The top surface is adapted to hold a piece of bait thereon for attracting a mouse thereto. The hold down bar attachment member is adapted to releasably hold a distal end of the hold down bar in an initial position, such that the hold down bar is removably held in the tensioned state via said spring, and is adapted such that when the improved catch member is moved from the initial position it releases said hold down bar. The attachment member comprises an attachment panel. The attachment panel is adapted to be placed adjacent the bottom surface of the catch platform.

Wherein the proximal end of the at least one elongated strap member is connected to the bottom surface of the attachment panel. Wherein the distal end of the at least one elongated strap member is adapted to be removably connected to the bottom surface of the attachment panel. Wherein the at least one strap member is adapted to be wrapped around the catch platform, the attachment panel, and the piece of bait to thereby removably hold the piece of bait securely to the top surface of the attachment body.

The present invention holds significant improvements and serves as an improved mouse trap apparatus. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an improved mouse trap apparatus, constructed and operative according to the teachings of the present invention.

FIG. 1A shows a perspective view illustrating an improved mouse trap apparatus prior to a mouse taking a piece of bait according to an embodiment of the present invention.

FIG. 1B shows a perspective view illustrating the improved mouse trap apparatus in an in-use condition with the mouse taking the piece of bait according to an embodiment of the present invention.

FIG. 2 is a perspective view illustrating the improved mouse trap apparatus according to an embodiment of the present invention.

FIG. 3 is a perspective view illustrating an attachment member of the improved mouse trap apparatus according to an embodiment of the present invention of FIG. 1.

FIG. 4 is a top perspective view illustrating a top surface of attachment member and catch platform of the improved mouse trap apparatus according to an embodiment of the present invention of FIG. 1.

FIG. 5 is a bottom perspective view illustrating a bottom surface having a hook and loop fastener system of the attachment panel of the improved mouse trap apparatus according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to rodent trap devices and more specifically relates to and more specifically relates to an improved mousetrap apparatus structured and arranged to function as a bait holder such that a rodent may not easily remove the bait from a mouse trap

Generally speaking,the improved mousetrap apparatus may comprise an catch platform, a first elongated strap, and a second elongated strap. The catch platform may comprise a rectangular shaped form having a top surface and a bottom surface. The top surface of the rectangular shaped form having a securing means for securing to a bottom side of a bait tray of a mousetrap. The securing means may comprise glue, or other simple securing means.

The bottom surface of the rectangular shaped form of the catch platform may comprise a hook and loop (Velcro) fastener. The hook and loop fastener may cover the entire bottom surface of the catch platform.

The first elongated strap and a second elongated strap may comprise two transparent straps having a secured end and a free end. The secured end of the elongated straps may be secured to a portion of the top surface of the catch platform. The first elongated strap and a second elongated strap may be disposed parallel to each other, and be manufactured of approximate equal length and size.

The free end of the elongated straps may comprise hook and loop material disposed on a portion of the straps near the free end. The free ends of the elongated straps may be manufactured to releasably couple to the hook and loop bottom surface of the catch platform.

With the top surface of the catch platform secured to a bait tray of a mouse trap, the first and second elongated straps may attach a piece of bait to the bait tray. The first and second elongated straps may wrap around the bait and attach to the hook and loop (Velcro) fastener of the bottom surface of the catch platform.

The present invention may improve the number of rodents caught in a mouse trap by preventing a rodent from easily removing bait from a mousetrap. The present invention may easy to use and reasonably priced such that it is a viable addition to a multitude of mouse traps.

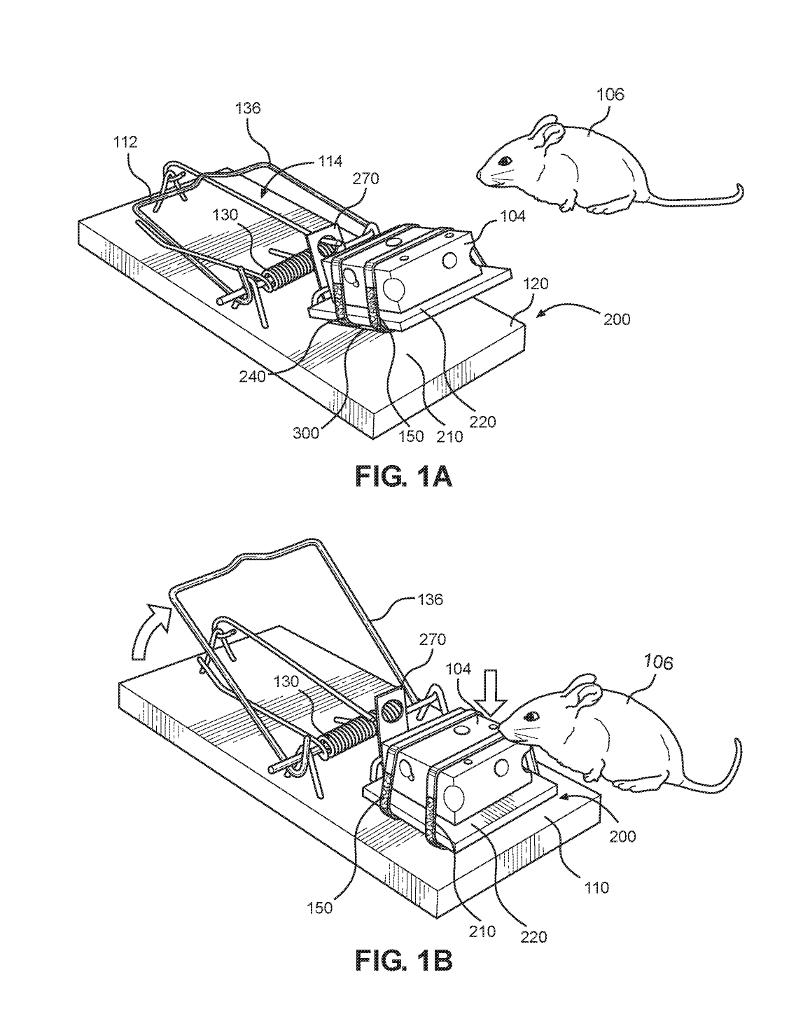

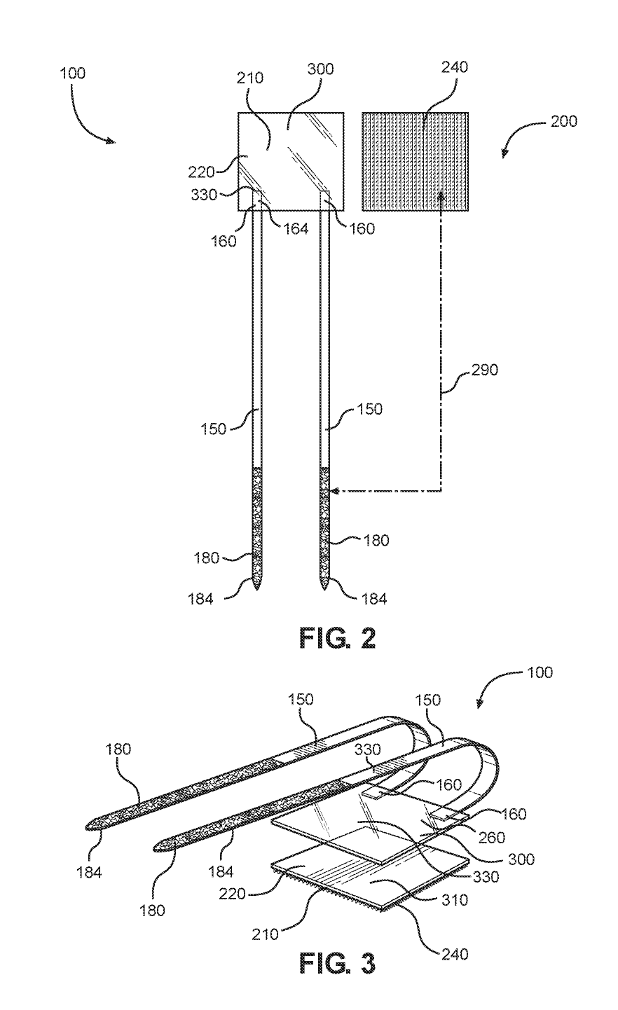

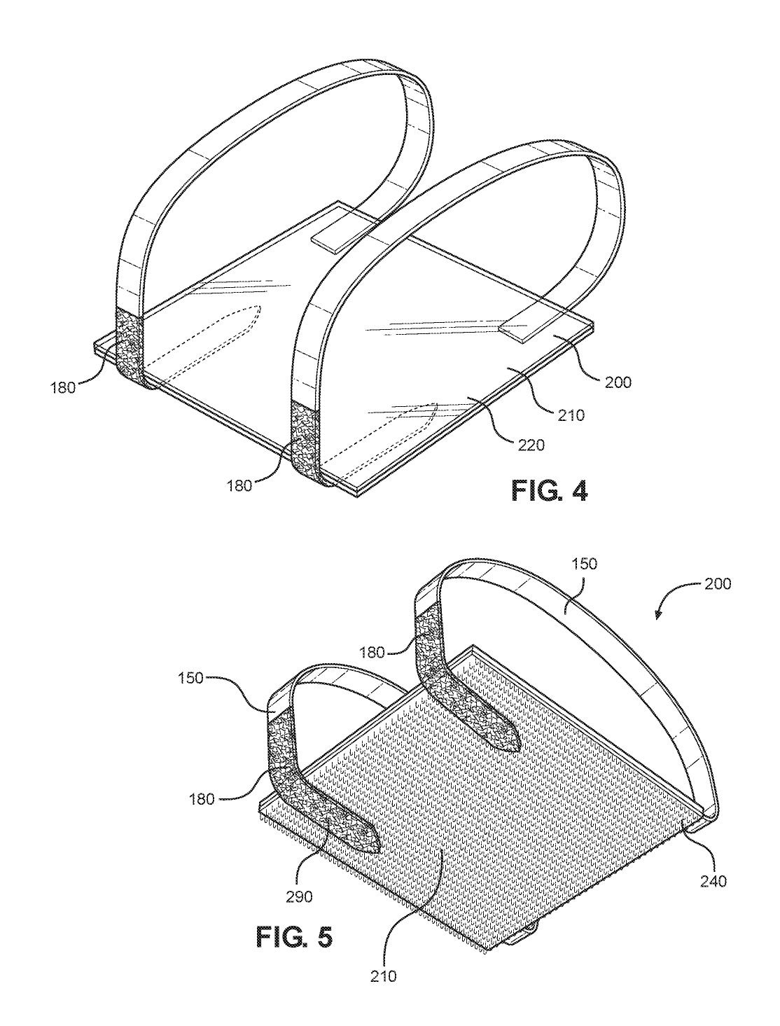

Referring now to FIGS. 1-5, showing perspective views illustrating improved mousetrap apparatus 100 according to an embodiment of the present invention of FIG. 1.

Improved mousetrap apparatus 100 comprising: platform 110 including top surface 120; spring 130; hammer 136; hold down bar 142; improved catch member 200 having catch platform 210; attachment member 300 having attachment panel 320; and at least one elongated strap member 150 including a proximal end 160 and distal end 180 as shown in FIG. 1A. Spring 130 is attached to top surface 120 of platform 130. Spring 120 is formed as a helical spring. Wherein hammer 136 is connected to spring 120 and is adapted to pivot with respect to platform 110. Wherein hold down bar 142 is connected to top surface 120 of platform 110 at proximal end 114 thereof, and is adapted to removably hold down hammer 136 in a tensioned state via spring 120.

Catch platform 210 of improved catch member 200 comprises top surface 220, bottom surface 240, and hold down bar attachment member 270. Top surface 220 is adapted to hold piece of bait 104 thereon for attracting mouse 106 thereto as shown in FIG. 1. Hold down bar attachment member 270 is adapted to releasably hold a distal end of hold down bar 142 in an initial position, such that hold down bar 142 is removably held in a tensioned state via spring 130, and is adapted such that when improved catch member 200 is moved from an initial position it releases hold down bar 142 as shown in in-use condition 108 of FIG. 1B. Wherein catch platform 210 is formed having a yellow color adapted to attract mouse 106 thereto.

Attachment panel 320 is adapted to be placed adjacent bottom 240 surface of catch platform 210 as shown in FIG. 3. Wherein attachment panel 320 is formed having a rectangular shape. Wherein attachment layer 300 is formed from a plastic material. Wherein said plastic material is transparent. Wherein proximal end 160 of at least one elongated strap member 150 is connected to bottom surface 240 of attachment panel 320. Wherein proximal end 160 of at least one elongated strap member 150 is connected to bottom surface 240 of attachment panel 320 via glue 164.

Wherein distal end 180 of at least one elongated strap member 150 is adapted to be removably connected to bottom surface 240 of attachment panel 320. Wherein at least one strap member 150 is adapted to be wrapped around catch platform 210, attachment panel 320, and piece of bait 104 to thereby removably hold piece of bait 104 securely to top surface 220 of catch platform 210.

Wherein bottom surface 240 of attachment panel 320 includes one of hook or loop material 250 thereon from hook and loop connector 290. Wherein distal end 180 of at least one elongated strap member 150 includes the other of one of hook or loop material 184 thereon from hook and loop connector 290, such that distal end 180 is adapted to be removably connected to bottom surface 240 of attachment panel 320. wherein bottom surface 240 of attachment panel 320 includes one of hook or loop material 250 thereon from hook and loop connector 290; and wherein distal ends 180 of two elongated strap members 150 include the other of one of hook or loop material 250 thereon from hook and loop connector 290, such that both distal ends 180 are adapted to be removably connected to bottom surface 240 of attachment panel 320 as shown in FIG. 5. Hook or loop material 250 covers entire bottom surface of attachment panel 320.

Wherein bottom surface 240 of attachment panel 320 of improved catch member 200 further includes attachment layer 330 connected thereto via glue 310 as shown in FIG. 3. Wherein proximal end 160 of at least one elongated strap member 150 is connected to attachment layer 330. Wherein distal end 180 of at least one elongated strap member 150 is adapted to be removably connected to attachment layer 330. Wherein bottom surface 240 of attachment layer 330 includes one of hook or loop material 250 thereon from hook and loop connector 290; and wherein distal end 180 of at least one elongated strap member 150 includes the other of one of hook or loop material 250 thereon from hook and loop connector 290, such that distal end 180 is adapted to be removably connected to bottom surface 240 of attachment layer 330.

Wherein at least one elongated strap member 150 is formed from a transparent material, such that a view of s piece of bait 104 is unobstructed to mouse 106 viewing piece of bait 104 as shown in FIG. 1. Wherein at least one elongated strap member 150 is formed from a material chosen from a list of materials consisting of plastic, nylon, cotton, aluminum, and leather. Wherein two elongated strap members 150 are of equal length and size. Wherein there are two said elongated strap members 150 spaced from one another; and wherein distal ends 180 of two elongated strap members 150 include the other of one of hook or loop material 250 thereon from hook and loop connector 290, such that both distal ends 180 are adapted to be removably connected to bottom surface 240 of attachment layer 330.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved mousetrap apparatus comprising:
a platform including:
a top surface;
a spring;
wherein said spring is attached to said top surface of said platform;
a hammer;
wherein said hammer is connected to said spring and is adapted to pivot with respect to said platform;
a hold down bar;
wherein said hold down bar is connected to said top surface of said platform at a proximal end thereof, and is adapted to removably hold down said hammer in a tensioned state via said spring; and
an improved catch member comprising:
a catch platform including:
a top surface;
wherein said top surface is adapted to hold a piece of bait thereon for attracting a mouse thereto;
a bottom surface; and
a hold down bar attachment member;
wherein said hold down bar attachment member is adapted to releasably hold a distal end of said hold down bar in an initial position, such that said hold down bar is removably held in said tensioned state via said spring, and is adapted such that when said improved catch member is moved from said initial position it releases said hold down bar;
an attachment member comprising:
an attachment panel;
wherein said attachment panel is adapted to be placed adjacent said bottom surface of said catch platform;
at least one elongated strap member comprising:
a proximal end;
wherein said proximal end is connected to said bottom surface of said attachment panel; and
a distal end;
wherein said distal end is adapted to be removably connected to said bottom surface of said attachment panel;
wherein said at least one strap member is adapted to be wrapped around said catch platform, said attachment panel, and said piece of bait to thereby removably hold said piece of bait securely to said top surface of said catch platform.

2. The improved mousetrap apparatus of claim 1, wherein there are two said elongated strap members spaced from one another.

3. The improved mousetrap apparatus of claim 2, wherein said two elongated strap members are adapted to be configured parallel to one another when said distal ends are connected to said bottom surface of said attachment panel.

4. The improved mousetrap apparatus of claim 1, wherein said bottom surface of said attachment panel includes one of hook or loop material thereon from a hook and loop connector; and
wherein said distal end of said at least one elongated strap member includes the other of said one of hook or loop material thereon from a hook and loop connector, such that said distal end is adapted to be removably connected to said bottom surface of said attachment body.

5. The improved mousetrap apparatus of claim 2, wherein said bottom surface of said attachment panel includes one of hook or loop material thereon from a hook and loop connector; and
wherein said distal ends of said two elongated strap members include the other of said one of hook or loop material thereon from a hook and loop connector, such that both distal ends are adapted to be removably connected to said bottom surface of said attachment panel.

6. The improved mousetrap apparatus of claim 1, wherein attachment panel is formed having a rectangular shape.

7. The improved mousetrap apparatus of claim 1, wherein said proximal end of said at least one elongated strap member is connected to said bottom surface of said attachment panel via glue.

8. The improved mousetrap apparatus of claim 4, wherein said hook or loop material covers the entire bottom surface of the attachment panel.

9. The improved mousetrap apparatus of claim 1, wherein said at least one elongated strap member is formed from a transparent material, such that a view of said piece of bait is unobstructed to a mouse viewing said piece of bait.

10. The improved mousetrap apparatus of claim 1, wherein said at least one elongated strap member is formed from a material chosen from a list of materials consisting of plastic, nylon, cotton, aluminum, and leather.

11. The improved mousetrap apparatus of claim 1, wherein said two elongated strap members are of equal length and size.

12. The improved mousetrap apparatus of claim 1, wherein said catch platform is formed having a yellow color adapted to attract mice thereto.

13. The improved mousetrap apparatus of claim 1, wherein said spring is formed as a helical spring.

14. The improved mousetrap apparatus of claim 1, wherein said bottom surface of said attachment panel of said improved catch member further includes an attachment layer connected thereto via glue; wherein said proximal end of said at least one elongated strap member is connected to said attachment layer; and wherein said distal end of said at least one elongated strap member is adapted to be removably connected to said attachment layer.

15. The improved mousetrap apparatus of claim 14, wherein a bottom surface of said attachment layer includes one of hook or loop material thereon from a hook and loop connector; and
wherein said distal end of said at least one elongated strap member includes the other of said one of hook or loop material thereon from a hook and loop connector, such that said distal end is adapted to be removably connected to said bottom surface of said attachment layer.

16. The improved mousetrap apparatus of claim 15, wherein there are two said elongated strap members spaced from one another; and wherein said distal ends of said two elongated strap members include the other of said one of hook or loop material thereon from a hook and loop connector, such that both distal ends are adapted to be removably connected to said bottom surface of said attachment layer.

17. The improved mousetrap apparatus of claim 14, wherein said attachment layer is formed from a plastic material.

18. The improved mousetrap apparatus of claim 17, wherein said plastic material is transparent.
